(19) United States
(12) Patent Application Publication
(10) Pub. No.: US 2010/0061829 A1
(43) Pub. Date: Mar. 11, 2010

(54) SYSTEM AND APPARATUS FOR PROGRESSIVE ROBOTIC TRUSS ASSEMBLY

(76) Inventors: David L. McAdoo, Alvarado, TX (US); Timothy K. McAdoo, Grand Prairie, TX (US); Danny Lee Rupe, Colleyville, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/533,767

(22) Filed: Jul. 31, 2009

Related U.S. Application Data
(60) Provisional application No. 61/096,071, filed on Sep. 11, 2008.

(51) Int. Cl. G05B 19/418; B25J 18/00

(52) U.S. Cl. 414/222.02; 901/14

(57) ABSTRACT

A truss assembly station may include a jigging table for assembling a truss thereon and a truss assembler. The truss assembler is disposed at a mobile gantry suspended a predetermined distance from a surface of the jigging table. The mobile gantry is configured to move relative to the surface. The truss assembler is configured to enable assembly of a truss from truss members by providing an automatic sequential placement of the truss members based at least in part upon a planned location of pre-plated truss members within an assembled truss.

### CROSS REFERENCE TO RELATED APPLICATIONS

This application claims the benefit of U.S. Provisional Application No. 61/096,071, filed Sep. 11, 2008, the contents of which are incorporated herein in their entirety.

### FIELD OF THE INVENTION

Embodiments of the present invention generally relate to truss fabrication and, more particularly, relate to a system and apparatus for improving truss fabrication automation.

### BACKGROUND OF THE INVENTION

Trusses are common components for many construction framing projects. However, despite the ubiquitous nature of trusses, it is relatively rare that any single truss design is replicated to a large extent. As such, many trusses are custom built for a particular construction project. Due to the highly customized residential and commercial construction markets, a strain is placed on truss manufacturers, which may be particularly acute in the area of set up. For that reason, much of the automation associated with truss fabrication has been focused on automating set up functions for cutting and assembly.

Currently, pieces of lumber are cut to the precise length and properly angled end, sorted and stacked after sawing, and transported to a staging area where truss assembly is performed. When the production schedule requires, the cut and sorted pieces may be moved to the assembly area along with needed connectors, which may include plates with teeth that imbed at least partially into wood members of the truss at their ends or along their length to hold the members together during the assembly process. The pieces may then be laid into an assembly jig, which provides a form or guide for member placement and truss assembly. The connectors may be placed on both top and bottom faces of the lumber at the joints between adjacent pieces.

Due to the custom nature of truss fabrication, it is often necessary to readjust the jig for each different truss. Accordingly, mechanisms have been developed to increase efficiencies related to setting up a jig. For example, jigging tables using lasers to outline jig or lumber patterns or having slidable guide members for more rapid adjustment of the jig have improved the ability of fabricators to customize jigs. However, the placement of lumber in the jig is typically done manually. The installation of connectors is also typically done by hand.

While the top face of the lumber is readily accessible, the bottom face is not since it is typically in contact with a jigging table or other substrate upon which the jig is provided. Accordingly, placement of a top plate, which is a connector engaging a top face of various members forming a joint in the truss, may not be difficult. In fact, various mechanisms including outlining a form of a plate on the various members have been developed to increase efficiency in placement of plates or connectors for the top faces of the lumber in the truss. However, it is typically necessary for the lumber pieces or members forming a particular joint to be simultaneously lifted so that the bottom plate can be slid underneath and properly located. Moreover, the location of the bottom plate is often determined by feel or merely from the positioning of edges that may be visible from above.

U.S. Pat. No. 5,440,977 to Poutanen describes one mechanism aimed at improving truss assembly by affixing connector or nail plates to some truss members prior to transporting the members to an assembly station. However, the assembly of truss members in Poutanen is manual. Although the prior plating of the connector plates may speed the truss assembly process, errors associated with manual handling and placement of truss members may still be introduced.

Given that truss manufacturing is likely to remain a highly customized process and also given that mechanisms for automating truss manufacturing may have the capability of providing time and cost savings that may present market advantages to those employing automation techniques, it may be desirable to introduce a system and/or various system components that may overcome at least some of the disadvantages described above, or further automate the truss assembly process.

### BRIEF SUMMARY OF THE INVENTION

Accordingly, embodiments of the present invention may provide an automated truss assembly system. As such, exemplary embodiments may enable increased efficiency in truss assembly by automating several or even all portions of the truss assembly process. Moreover, a truss assembly system of an exemplary embodiment of the present invention may include modular elements that may be instantiated in a truss assembly process in any order and at time intervals that suit a truss manufacturer's budget or needs. Accordingly, for example, both the efficiency and quality of truss manufacturing may be improved.

In an exemplary embodiment, a truss assembly station is provided. The truss assembly station may include a jigging table for assembling a truss thereon and a truss assembler. The truss assembler may be disposed at a mobile gantry suspended a predetermined distance from a surface of the jigging table. The mobile gantry may be configured to move relative to the surface. The truss assembler may be configured to enable assembly of a truss from truss members by providing an automatic sequential placement of the truss members based at least in part upon a planned location of pre-plated truss members within an assembled truss.

In another exemplary embodiment, a truss assembler is provided. The truss assembler may include a mobile gantry suspended a predetermined distance from a surface of a jigging table. The mobile gantry may be configured to move relative to the surface of the jigging table. The truss assembler may be configured to enable assembly of a truss from truss members by providing an automatic sequential placement of the truss members based at least in part upon a planned location of pre-plated truss members within an assembled truss.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view illustrating a system that may benefit from exemplary embodiments of the present invention;

FIG. 2 illustrates a top view of a work piece or truss member having a top plate on a top face of a leading end of the work piece and a bottom plate on a bottom face of a middle portion of the work piece according to an exemplary embodiment of the present invention;

FIG. 3 is a perspective view illustrating an alternative system that may benefit from exemplary embodiments of the present invention; and

FIG. 4 illustrates an expanded view of a truss assembly station in which an operation for practicing truss assembly is shown according to an exemplary embodiment of the present invention;

FIG. 5 illustrates a subsequent operation to that shown in FIG. 4 according to an exemplary embodiment of the present invention;

FIG. 6 illustrates a subsequent operation to that shown in FIG. 5 according to an exemplary embodiment of the present invention;

FIG. 7 illustrates a subsequent operation to that shown in FIG. 6 according to an exemplary embodiment of the present invention;

FIG. 8 illustrates a subsequent operation to that shown in FIG. 7 according to an exemplary embodiment of the present invention;

FIG. 9 illustrates a subsequent operation to that shown in FIG. 8 according to an exemplary embodiment of the present invention;

FIG. 10 illustrates a subsequent operation to that shown in FIG. 9 according to an exemplary embodiment of the present invention;

FIG. 11 illustrates a subsequent operation to that shown in FIG. 10 according to an exemplary embodiment of the present invention;

FIG. 12 illustrates a subsequent operation to that shown in FIG. 11 according to an exemplary embodiment of the present invention;

FIG. 13 illustrates a subsequent operation to that shown in FIG. 12 according to an exemplary embodiment of the present invention;

FIG. 14 illustrates a subsequent operation to that shown in FIG. 13 according to an exemplary embodiment of the present invention;

FIG. 15 illustrates a subsequent operation to that shown in FIG. 14 according to an exemplary embodiment of the present invention; and

FIG. 16 illustrates a subsequent operation to that shown in FIG. 15 according to an exemplary embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout. Furthermore, as used herein “or” may be interpreted as a logical operator that results in true whenever one or more of its operands are true.

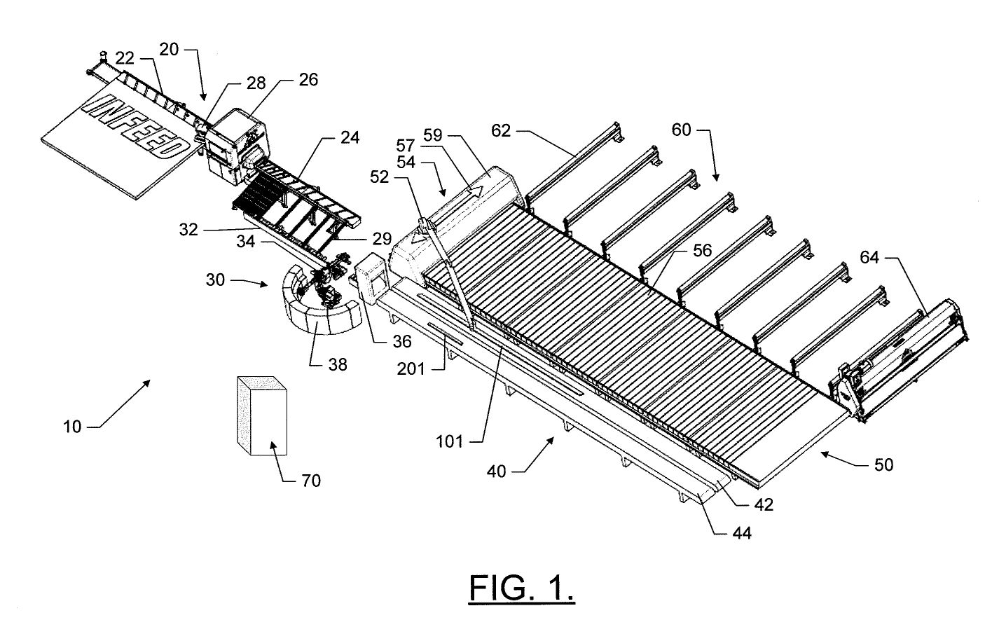

FIG. 1 is a basic block diagram illustrating a system 10 that may benefit from exemplary embodiments of the present invention. As shown and described herein, the system 10 could be employed in the context of a truss manufacturing process. The system 10 may include various stations in which each station performs a particular function with respect to the overall function of the system 10. In particular, each station may represent a functional module which can be implemented in accordance with embodiments of the present invention. As such, embodiments of the present invention need not include, and in many cases may not include, every station. Indeed, embodiments of the present invention may enable the utilization of one or more, or even all of the stations for improving corresponding aspects of a truss manufacturing process, while not necessarily requiring a full implementation of the system shown. Stations not implemented in any particular embodiment may be replaced with conventional mechanisms for performance of corresponding functions or, for example, corresponding functions may be manually accomplished.

As shown in FIG. 1, the system 10 may include a cutting station 20, a pre-plating station 30, a pre-plated member transport station 40, a truss assembly station 50 and a truss transport station 60. Each of the stations will be described below in relation to the functions performed at the corresponding stations and exemplary structures for performing each respective function according to an exemplary embodiment. However, in some instances specific structures alternative to those shown in the drawings and descriptions that follow may also be employed.

The cutting station 20 may include an infeed assembly 22 and an outfeed assembly 24, each of which may be operatively coupled with a cutting device such as a saw. In an exemplary embodiment, the saw may be, for example, a linear saw 26 such as the Alpine Linear Saw (ALS) produced by Alpine Engineered Products. Thus, the linear saw 26 may be configured to receive stock lumber such as a board or piece of lumber transported linearly to the linear saw 26 by the infeed assembly 22 and transported linearly away from the linear saw 26 by the outfeed assembly 24. After cutting by the linear saw 26, a work piece is transported away from the cutting station 20. The work pieces referred to herein may include exemplary truss members or truss components.

In an exemplary embodiment, the infeed assembly 22 may include a conveyor such as rollers, a conveyor belt or other form of conveyance for providing a distal end of an elongated work piece, such as an end portion of a piece of lumber, into the linear saw 26. Similarly, the outfeed assembly 24 may also include a conveyor such as rollers, a conveyor belt or other form of conveyance for receiving a distal end of the work piece such from the linear saw 26 to transport the work piece from the linear saw 26 in a linear fashion. The rollers may all be powered or non-powered rollers. Alternatively, only certain ones of the rollers may be powered. Furthermore, in some embodiments, the conveyor may include a combination of belts and rollers. According to an exemplary embodiment, the infeed assembly 22, the outfeed assembly 24 and the linear saw 26 may all operate on a single board in sequence to enable the board to pass through the cutting station 20 in a linear or inline fashion.

The linear saw 26 may include an intake motion controller and an outbound motion controller that may take control of a work piece provided from the infeed assembly 22 and provide control to the outfeed assembly 24, respectively, for a work piece cut in the linear saw 26. In this regard, one of the intake motion controller and the outbound motion controller may operate as a master at any given time while the other operates as a slave. Each of the inbound motion controller and/or the outbound motion controller may be equipped to engage and transport a work piece through the linear saw (e.g., via a belt or roller mechanism). In an exemplary embodiment, both inbound motion controller and the outbound motion controller may include a clamping top and bottom roller or belt assembly between which the workpiece is passed and driven through frictional engagement. Dependent upon the work piece being cut, or the stage of the cutting of the work piece, the intake motion controller and the outbound motion controller may alternate master/slave operations to ensure proper cutting of the work piece as the work piece is passed linearly though the linear saw 26. The conveyor of either or both of the infeed assembly 22 and the outfeed assembly 24 may be powered or may be fed manually until the intake motion controller receives an inbound work piece or until the outbound motion controller releases an outbound workpiece.

In an exemplary embodiment, the linear saw 26 may include, for example, prior to the intake motion controller, a marking device 28. The marking device 28 may be configured to print or otherwise place indicia on a work piece to identify the work piece and/or provide markings for use in pre-plating, ordering, or arranging the work piece at a later station. The cutting information is provided to the saw through a CAD-CAM communication of the truss design details to the saw computer. The indicia may be an ink, paint or other visible marking placed on the work piece. Alternatively, the indicia may be a barcode, a radio frequency identification (RFID) tag or other marking that may be read by a vision system or RFID tag reader or other means.

In an exemplary embodiment, the linear saw 26 may be operated by a machine controller (not shown) employing software or otherwise configured to enable pre-programming of cuts to be performed on a particular board. The indicia may typically be used to provide information to operations downstream from the saw. Thus, for example, the linear saw 26 may get all the information it needs to cut and mark truss pieces from the CAD-CAM communication described above. The machine controller may also be in communication with a master control station 70, which may communicate with one or more of the various stations of embodiments of the present invention. The control station 70 may include at least a processor, memory, and a user interface for enabling the user to interface with the control station 70 to direct operations or pre-program operations of one or more of the stations as described in greater detail below. As an alternative, rather than using a central control mechanism such as the control station 70, embodiments of the present invention may be operated by entering job related information into a central database or local database of a respective machine controller of a device of each of the various stations described herein. As such, at each respective machine controller, job related information may be accessed and the corresponding device may operate according to specifications provided in association with the selected job. Each job may correspond to truss design data defining, for example, the length and types of cuts to be applied to each truss member or work piece, the positions and orientations of the plates for each joint, ordering of the truss members for placement in a jig and positions of such members in the jig, etc.

In an exemplary embodiment, the control station 70 may store an application comprising computer readable program code portions (e.g., in the memory) for execution by the processor in which the execution of the application enables the provision of instructions to one or more respective stations for performance of a respective function as described in greater detail below. As such, the control station 70 may be in communication with one or more of the various stations (e.g., the cutting station 20, the pre-plating station 30, the pre-plated member transport station 40, the truss assembly station 50 and the truss transport station 60) or with certain components or devices of the respective stations as described in greater detail below. In connection with an exemplary embodiment, the control station 70 may be in communication with the linear saw 26 and/or the marking device 28 to provide information regarding how to cut and/or mark each work piece. In an exemplary embodiment, the control station 70 may further store (e.g., in the memory) engineering drawings that may describe, for example, specifications for truss assembly (e.g., truss design data). In some cases, various different truss designs may be stored in association with different jobs via a job identifier, or each different truss design may be associated with its own unique job or truss identifier. Thus, for example, the control station 70 may be configured to provide information regarding a particular job or job identifier to one or more stations and a particular device or component of a respective station to which information is provided (e.g., the cutting station 20, the pre-plating station 30, the pre-plated member transport station 40, the truss assembly station 50 and the truss transport station 60) may utilize information regarding the identified job or truss in order to adjust set up parameters, operating parameters or positioning criteria based on the information. Thus, a particular work piece may receive treatment at each station in accordance with a single overall plan, job description or engineering drawing to ensure appropriate operations including cutting, transport, pre-plating, placement, assembly, etc., are performed with respect to each different work piece that may ultimately be used as a truss member for assembly of a truss, or for an entire job or work order comprising multiple trusses.

In this regard, for example, after being cut by the linear saw 26, the work piece may be linearly extracted until the work piece is entirely out of the linear saw 26 and passed along to the outfeed assembly 24. In some instances, the outfeed assembly 24 may pass the work piece on to the pre-plating station 30 still in a linear fashion. As such, for example, the work piece may be extracted from the linear saw 26 and passed along to the pre-plating station 30 by the outfeed assembly 24 while remaining inline. However, in an alternative embodiment as shown in FIG. 1, the outfeed assembly 24 may include a translation mechanism for providing the work piece to the pre-plating station 30 by translating the work piece to a pre-plating intake subassembly 32 of the pre-plating station 30. The translation mechanism may include rollers, belts or other conveying mechanisms. However, in an exemplary embodiment, the translation mechanism may simply include a series of bars or skids extending substantially perpendicular to the elongated length of the work piece as the work piece extends out of the linear saw 26. In some embodiments, additional rollers or skids may extend between (and substantially perpendicular to) at least some adjacent ones of the bars or skids that extend from the outfeed assembly 24 to the pre-plating intake assembly 32.

FIG. 1 shows the outfeed assembly 24 of the cutting station 20 being placed in operable communication with the pre-plating intake assembly 32 via a translation assembly 29 including the bars and skids described above. In an exemplary embodiment, the outfeed assembly 24 may be at a higher elevation than the pre-plating intake assembly 32 so that, in response to work piece being lifted out or pushed laterally with respect to the direction of exit from the linear saw 26, the work piece may slide by gravity to the pre-plating intake assembly 32 via the bars or skids of the translation assembly 29. In some exemplary embodiments, the translation assembly 29 may include retractable or removable gates that may stop work pieces from entering the pre-plating intake assembly 32 until such entry is desired. As such, the translation assembly 29 may be able to support a series of work pieces or a queue of lumber that is ordered for inclusion in the assembly of a truss.

In an exemplary embodiment, the pre-plating intake assembly 32 of the pre-plating station 30 may include a conveyor such as a roller, belt or other conveying device for linearly transporting the work piece into a pre-plating device 34, where the work piece may have a connector (e.g., a truss plate) installed by the pre-plating device 34. Connectors or plates as described herein typically have teeth or protrusions extending from one face. The teeth are typically seated within the material of the work piece to hold the plate in place with respect to the board or boards that are joined by the plate. By pre-plating a work piece, a plate is placed on the first piece to a joint at a position where a joint will be formed in order to enable formation of the joint by the addition of additional boards to the joint until the last board is added (having a plate that mirrors the plate on the first board of the joint). The plate on the first piece to the joint will be placed on the side of the piece that is facing down when placed in the assembly jig. The mirror plate on the last piece to the joint will be placed on the side that is facing up.

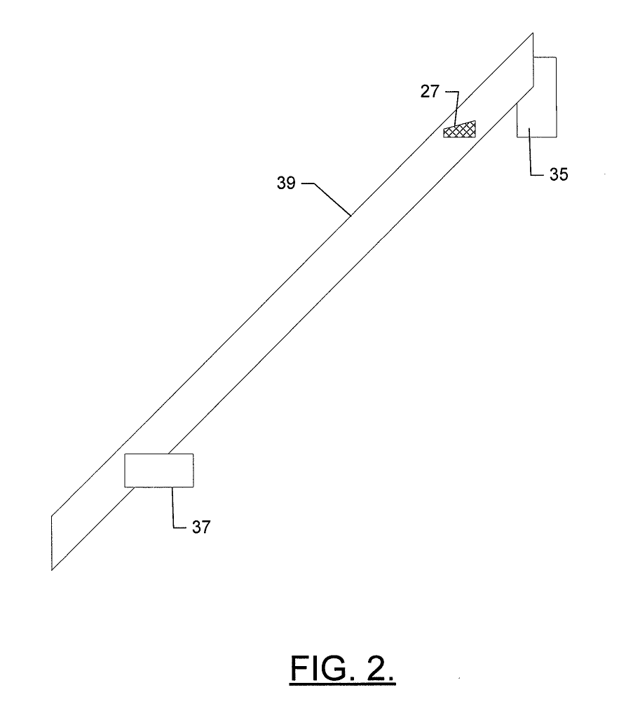

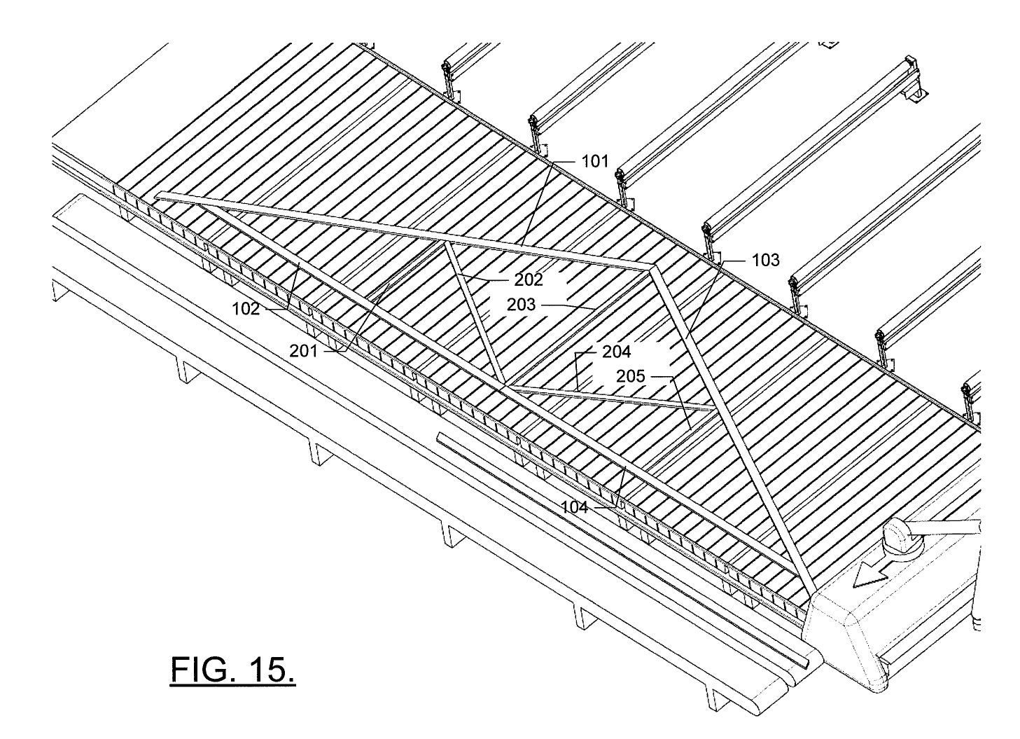

The pre-plating device 34 may, for example, include an intake motion controller and an outbound motion controller (e.g., roller assembly 36) similar to those employed by the linear saw 26. In this regard, for example, the intake motion controller may include a top and bottom roller configured to engage the work piece and control movement of the work piece in a linear direction through the pre-plating device 34 until control of the movement is passed to the outbound motion controller. The outbound motion controller of an exemplary embodiment may include the roller assembly 36 including both a top roller and a bottom roller. The top roller may be configured to engage a top surface of the work piece while the work piece passes through the roller assembly 36 and the bottom roller may be configured to engage a bottom surface of the work piece as the work piece passes through the roller assembly 36. As such, the spacing between the rollers of the roller assembly 36 may be variable based on the thickness (or narrowest dimension) of the work piece. When spaced in this manner, the rollers may roll a connector plate into the work piece until the teeth of the connector plate are fully embedded and the tooth side surface of the connector plate is in contact with the lumber over the area of engagement. As can be seen in FIG. 2, all pre-plates have some area of engagement with the work piece. The area that does not engage the piece on which the pre-plate is placed will, in part or in whole, engage other work pieces when assembled into the truss as shown in FIG. 15.

According to an exemplary embodiment, the pre-plating device 34 may be a device such as, for example, a robot (e.g., a commercially available robot with a customized attachment for grabbing and partially seating plates), which may be programmed or otherwise configured to pre-plate the cut work pieces provided from the cutting station 20 to the pre-plating station 30. In some instances, the pre-plating device 34 may include or be in communication with an indicia reader (e.g., either an RFID reader or a visual reading system), which may be configured to read the indicia provided by the marking device 28 to enable proper pre-plating of a corresponding work piece. In this regard, the pre-plating device 34 may be programmed or configured to obtain a plate from a plate storage facility 38. The plate storage facility 38 may be an array of plates of various different sizes, which may be accessible to the pre-plating device 34. As such, the pre-plating device 34 may access and/or extract a particular plate from the plate storage facility in order to enable the pre-plating device 34 to attach the particular plate to a work piece at a location and orientation which has been predetermined (e.g., via truss design data) by an engineering program which designed the truss prior to the beginning of the truss fabrication process.

In an exemplary embodiment, the control station 70 may be in communication with the pre-plating device 34 to provide the pre-plating device 34 with instructions regarding plate selection and/or positioning. Alternatively, instructions regarding plate selection and/or positioning may be made locally at the pre-plating device 34 based on stored information (e.g., associated with a local machine controller of the pre-plating device 34) or based on the indicia. In this regard, in an exemplary embodiment, the indicia provided by the marking device 28 may include information indicating what size or type of plate to obtain from the plate storage facility 38 and may also indicate at what point or at what orientation to place the plate on the work piece. Thus, for example, based on a selected job identifier (e.g., from the control station 70 or the machine controller of the pre-plating device 34), the pre-plating device 34 may be configured to identify a particular work piece (e.g., based on the indicia read thereon) and, for the particular work piece and the selected job identifier, select a corresponding plate and place the selected plate at a position and in an orientation that is appropriate for the particular work piece. As another alternative, the job identifier itself may be indicated in the indicia so that the pre-plating device 34 (or the control station 70) may look up the job identifier associated with the work piece and, for example, information directing how the work piece is to be handled according to the corresponding job identified.

As an example, a piece of lumber may include indicia placed on the lumber by the marking device 28. The indicia may be read by the indicia reader of the pre-plating device 34. The pre-plating device 34 may extract plating instructions from the control station 70 or from a local database indicating, for the piece of lumber identified in relation to the corresponding job identifier (e.g., either pre-programmed or looked up based on the indicia), which plate should be selected. The pre-plating device 34 may then access the selected plate and, either based on the job identifier and the identified piece of lumber or based on information determinable from the indicia (e.g., decoded information or information looked up in a database), determine at what position or in what orientation to place the plate. While the lumber is controlled either by the intake motion controller for plating at or near a leading end of the piece of lumber, by the outbound motion controller for plating at or near a trailing end of the piece of lumber, or by whichever of the intake motion controller and the outbound motion controller is operating as the master motion controller for plating in a middle portion of the piece of lumber (e.g., where both the intake motion controller and the outbound motion controller may engage the piece of lumber during pre-plating) the pre-plating device 34 may affix the plate to the piece of lumber in a position and at an orientation that correlates to the position and orientation indicated in truss design data.

As an alternative, rather than receiving an identity of the work piece or decoding/looking up information indicating where to plate the work piece, the indicia itself may indicate where and/or how to pre-plate the work piece. In this regard, for example, one or both of the location and orientation of the indicia may determine at what position or in what orientation to place the plate. As such, the indicia may operate as an index mark. In an exemplary embodiment, the plate may be placed in a predefined relationship with respect to the index mark. Thus, for example, the index mark could indicate a mark or line with which an edge of the plate may be aligned. Alternatively, the index mark could be a predefined distance and/or orientation from the edge or another landmark position of the work piece or plate (e.g., center, corner, etc.). In some cases the index mark could provide indications regarding at what distance or in what orientation with respect to a landmark position of the work piece, the plate should be placed.

In some embodiments the indicia may indicate on which side of the work piece the plate is to be attached. In this regard, the pre-plating device 34 may be enabled (e.g., by an articulated robot arm) to approach a work piece from either a top looking down or bottom looking up trajectory in order to plate either side of the work piece. Thus, for example, the pre-plating device 34 may be configured to apply a plate to either side of the work piece (e.g., either the top face or bottom face of a piece of lumber) while the work piece is passed through a gap between the intake motion controller and the outbound motion controller. Moreover, embodiments of the present invention may enable the pre-plating device 34 to apply a plate with respect to an index mark that is on the opposite side of the work piece than the side on which the plate is to be applied. In some instances, the pre-plating device 34 may place multiple plates on the same work piece, or no plates at all, dependent upon the position of the work piece in the truss to be assembled. If multiple plates are attached to the same work piece, the plates may even be applied such that at least one plate is affixed to an opposite side of the work piece with respect to a side on which at least one other plate is affixed. Thus, for example, as shown in FIG. 2, the pre-plating device 34 may place a plate (e.g., bottom plate 35) on a bottom face of a leading end of a piece of lumber (e.g., board 39) and place a plate (e.g., top plate 37) on a top face of a trailing end or middle portion of the same piece of lumber. FIG. 2 also shows, for exemplary purposes, an exemplary indicia 27 on the top face of the work piece. In yet another embodiment, the plate placement, order of attachment and side of attachment may all be independent of the indicia.

In some embodiments the work piece may be momentarily stopped for the application of the plate. However, in other embodiments, it may be desirable to actuate the pre-plating device 34 for plate application with timing and precision enabling pre-plating of a continuously moving work piece. Furthermore, although an exemplary embodiment is described herein in which the work piece (e.g., a piece of lumber having two opposing wider faces that are oriented up and down, respectively) is transported such that the top and bottom faces are the wider faces of the work piece, it may also be possible to practice embodiments of the present invention by transporting the work piece through the pre-plating device 34 on its side. In other words, the work piece may be tilted at any angle up to a ninety degree angle as it passes through the pre-plating device 34. Moreover, each work piece could be tilted to place an appropriate side (e.g., a side intended to receive a plate) toward the pre-plating device 34 to reduce the need for the pre-plating device 34 to approach the work piece at multiple different trajectories.

In an exemplary embodiment, the pre-plating device 34 may seat the plate into the work piece at least partially, while the roller assembly 36 may fully seat the plate. In this regard, for example, the pre-plating device 34 may utilize an electric, pneumatic, hydraulic or other suitably powered compression mechanism for partially seating the plate prior to passage of the plate through the roller assembly 36. Other alternatives than compression mechanisms are also possible. For example, plates may be fastened into position with a staple or nails that are automatically applied by the pre-plating device 34 while the pre-plating device 34 holds the plate in the proper position. After passing through the roller assembly 36, the pre-plated work piece may be provided to the pre-plated member transport station 40.

The pre-plated member transport station 40 may receive a work piece from the roller assembly 36 of the pre-plating station 30 for transport to the truss assembly station 50. In an exemplary embodiment, as shown in FIG. 1, the pre-plated member transport station 40 may include one or more member transporters. In this regard, for example, a first member transporter 42 and a second member transporter 44 may be placed proximate to each other and to the truss assembly station 50 in order to transport work pieces from the pre-plating station 30 to an area near where the respective work pieces are likely to be employed in truss assembly at the truss assembly station 50. Thus, in some embodiments, the first and second member transporters 42 and 44 may extend linearly in a direction parallel to the direction of work piece travel through the pre-plating station 30 (which may also be parallel to the direction of work piece travel through the linear saw 26). Moreover, the first and second member transporters 42 and 44 may be in close proximity both to each other and to the truss assembly station 50 such that a long axis of each of the first and second member transporters 42 and 44 is substantially parallel to a long axis of the truss assembly station 50. Notably, although FIG. 1 shows an exemplary embodiment in which two member transporters are utilized, alternative embodiments may employ only one member transporter or more than two transporters. Furthermore, although FIG. 1 shows the member transporters on the same side of the truss assembly station 50, the member transporters could alternatively be disposed on opposite sides of the truss assembly station 50.

In an exemplary embodiment, there may be a separate saw and/or pre-plating device 34 for each respective member transporter. However, as an alternative, a single saw and/or pre-plating device 34 may service multiple member transporters. For example, a diverting mechanism (not shown), such as a swinging gate, may steer work pieces exiting the pre-plating station 30 to a corresponding one of the first and second member transporters 42 and 44 based on the truss design data. Alternatively, a central transport section may extend from the outfeed of the pre-plating station 30 and work pieces may be pushed off the central transport in either direction to land on a respective one of the first member transporter 42 or the second member transporter 44. In another exemplary embodiment, a computer associated with the control station 70 may select the target transport, based on efficient queuing decisions, prior to the pre-plating operation. The control station 70 may then direct the positioning of the piece to be pre-plated in line with that transport before the pre-plating operation takes place. In such a case, the pre-plating system may be made to be wide enough to handle the two potential paths. The work piece may then go through the pre-plate operation in line with the target transport and no sideways movement of the piece may be required after the pre-plate has been applied.

Notably, the pre-plated member transport station 40 and other devices referred to hereinafter that include the term “pre-plated” in their names do not necessarily only operate on pre-plated work pieces. To the contrary, as indicated above, since the pre-plating device 34 only plates those work pieces that are to be pre-plated in accordance with the job being performed (e.g., based on truss design data), some work pieces may pass through the system 10 without being pre-plated. As such, in more general terms, a member may merely be considered a work piece that has passed through the pre-plating device 34 or, more specifically, through the pre-plating station 30 since in some embodiments work pieces that are not to be pre-plated may bypass the pre-plating device 34. Meanwhile, a device having the term “pre-plated” in its name may therefore merely be indicative of the fact that the device can handle members that are pre-plated or members that are not pre-plated.

Either or both of the first and second member transporters 42 and 44 may be embodied as a conveying mechanism configured to transport work pieces (e.g., lumber) in a linear fashion (e.g., with an end of one work piece following an end of a preceding work piece such that, while being transported, adjacent work pieces on one of the transporters are inline or lie more or less in the same line with each other). As such, the first and second member transporters 42 and 44 may each include a conveyor of any suitable type such as, for example, a conveyor belt or a series or rollers. In some embodiments, since the work pieces transported by the pre-plated member transporter 42 may include plates that are partially seated attached thereto, it may be beneficial to use a conveyor belt or at least closely spaced rollers for the conveying mechanism in order to reduce the likelihood of a plate being caught in the conveying mechanism which might either remove the plate or jam the conveying mechanism.

The first and second member transporters 42 and 44 may each be configured to transport a work piece to a position proximate to the truss assembly station 50 in an inline fashion. When the work piece arrives at a portion of the first or second member transporter 42, 44, the work piece may be placed in a position relatively near to the location on the truss assembly station 50 from which the work piece can be moved in a relatively efficient manner. In this regard, for example, the work piece may be conveyed to a portion of either the first or second member transporter 42, 44 that is proximate to the installed or assembled location that the work piece will have in the assembled truss. Once located proximate to the truss assembly station 50, a vision system associated with the truss assembler 52 may be used to accurately determine where a particular work piece is grasped in order to enable precision placement by the truss assembler 52.

Alternatively or additionally, the pre-plated member transport station 40 may include or be in communication with a reader such as a vision system or an RFID reader to read the indicia 27 placed on the work piece by the marking device 28. Thus, for example, if the vision system reads the indicia and determines that the corresponding work piece should be placed in a particular location of an assembled truss based on the truss design data, the pre-plated member transport station 40 may index or move the work piece to a location at the pre-plated member transport station 40 that is proximate to (or relatively near) the particular location.

The truss assembly station 50 may include a truss assembler 52 (e.g., a truss assembly robot) that may be suspended from a mobile gantry 58 over a jigging table 56. The jigging table 56 may be a substantially flat surface upon which truss assembly may be performed. Thus, the jigging table 56 may be of a size large enough to accommodate trusses of sizes contemplated for assembly. In some embodiments, the jigging table 56 may typically be extended longer in a first direction to support the longest dimension (e.g., the length) of an assembled truss and shorter in a second direction that is substantially perpendicular to the first direction in order to support the height of the assembled truss. However, in alternative embodiments, the jigging table 56 may be further extended in the first direction in order to enable multiple trusses to be simultaneously assembled on a single jigging table 56.

In an exemplary embodiment, the jigging table 56 may support the mobile gantry 58, which may be embodied as a single roller gantry that may be configured to ride over substantially the entire length of the jigging table 56. In this regard, for example, the mobile gantry 58 may be suspended over the jigging table 56 at a height above the table that corresponds substantially to the thickness of the work pieces used for truss assembly. Thus, when the single roller gantry 58 rolls over the jigging table 56, plates may be partially seated for joints between various assembled work pieces or members. In this regard, each such joint may include at least two members having a plate already fully seated in those respective members at the pre-plating station 30 (e.g., a bottom plate in the first member placed and a top plate seated in the last member placed for the joint). However, any additional members other than the first and last members for any particular joint may not have the plate partially or fully seated within them until the mobile gantry 58 presses the plate therein to partially seat the plate. Likewise, the top plate may not have been seated in the first member and the bottom plate may not have been seated in the last member until the mobile gantry 58 presses the plate therein.

The mobile gantry 58 may be housed in or integrally a portion of a suspension carriage 59 that may ride, for example, on tracks that extend along an outer perimeter of the jigging table 56 along the first direction. Thus, one mobile gantry 58 may service a plurality of truss assembly stations on a single jigging table 56. The suspension carriage 59 may house a roller that may extend substantially perpendicular to a long axis of the jigging table 56 in order to enable the roller to roll over the length of the jigging table 56 when the mobile gantry 58 is moved from one end of the jigging table 56 to the opposite end. The suspension carriage 59 may also house or serve as a platform supporting other components in addition to the roller. For example, as shown in FIG. 1, the truss assembler 52 may utilize the suspension carriage 59 as a stable platform from which the operations of the truss assembler 52 may be performed. Other components supporting operation of the truss assembler 52 and/or the mobile gantry 58 may also be housed or supported via the suspension carriage.

In an exemplary embodiment, the mobile gantry 58 may be powered by any suitable mechanism that may provide motion control with respect to the position of the mobile gantry 58 relative to the jigging table 56. In this regard, for example, the control station 70 may be in communication with, or act as, a motion control unit that may be configured to control the position of the mobile gantry 58. As such, for example, the motion control unit (e.g., the control station 70) may include or be in communication with numerous sensors positioned along a length of the jigging table (e.g., in the tracks extending along opposite edges of the jigging table 56 or on the surface of the jigging table 56) to determine current position of the mobile gantry 58. Alternatively, the suspension carriage 59 may house sensors that can determine position relative to the jigging table 56. Based on the determined position of the mobile gantry 58, and based on a desired position for the mobile gantry based on the current state of truss assembly, the motion control unit may drive or direct the driving of the mobile gantry 58 over the surface of the jigging table 56. In an exemplary embodiment, the motion control unit may include or be in communication with a drive assembly that may be housed within the suspension carriage 59. The drive assembly may include one or more electric motors or any other motion controller configured to drive the mobile gantry 58 relative to the jigging table. In an exemplary embodiment, one or more servos or servomotors (e.g., with position monitoring devices built in) may be employed to drive the mobile gantry 58.

The truss assembler 52, which according to an exemplary embodiment, may include a robot supported atop the mobile gantry 58, may be configured to select and grab a particular work piece in order to transport the work piece from either of the first and second member transporters 42 and 44 to the jigging table 56. The truss assembler 52 may then be configured to place the selected work piece (which may or may not be pre-plated) onto the jigging table 56 in a correct position based on an engineering plan (e.g., a truss design or job). In an exemplary embodiment, the truss assembler 52 may be in communication with the control station 70 to receive information about the engineering plan such as a job identifier or truss design data. However, as an alternative, the job identifier or truss design data may be locally entered into and/or accessed at the truss assembler 52 (e.g., via a machine controller of the robot). The truss assembler 52 may then assemble a truss based on the truss design data using work pieces provided by the first and second member transporters 42 and 44.

In an exemplary embodiment, the truss assembler 52 may take work pieces from the first and second member transporters 42 and 44 in the order in which the work pieces are provided in the first and second member transporters 42 and 44 and apply the work pieces in their respective positions on the jigging table 56 according to truss design data. In such an embodiment, it may be assumed that the work pieces were cut and pre-plated (or passed through the pre-plating station 30) in an order that enabled the provision of work pieces to the first and second member transporters 42 and 44 in the general sequence or order in which the work pieces are to be assembled according to the truss design data provided either locally at various stations or via the control station 70.

In an alternative embodiment, the truss assembler 52 may further include or be in communication with a reader (e.g., a vision system or RFID reader) such that the truss assembler 52 may read (or interrogate) each work piece on either of the first and second member transporters 42 and 44 in order to find and select the next piece in sequence to be placed on the jigging table 56. If needed, the truss assembler 52 may be configured to search for the next piece.

Regardless of how the next piece to be added to the jigging table 56 is determined, once the next piece is found, the next piece may be selected (e.g., via an articulated robot hand) by the truss assembler 52 and transported using a combination of motions of the mobile gantry 58 along its track, the truss assembler 52 supported atop the mobile gantry 58, and the multiple degrees of freedom of the truss assembler 52 to the jigging table 56. As shown in FIG. 1 (e.g., by double arrow 57), the truss assembler 52 may also be moveable along a direction substantially perpendicular to the direction of motion of the mobile gantry 58. In an exemplary embodiment, a separate drive mechanism may be provided to move the truss assembler 52 relative to a surface of the suspension carriage 59. The drive mechanism may, for example, also include a servomotor in order to enable motion control of the truss assembler in the direction substantially perpendicular to the long axis of the jigging table 56. The servomotor driving the mobile gantry 58 in a direction substantially parallel to the long axis of the jigging table 56 and the servomotor driving the truss assembler 52 in a direction substantially perpendicular to the long axis of the jigging table 56 may each be in communication with or controlled by the control station 70. Accordingly, the truss assembler 52 may be positioned relative to the surface of the jigging table 56 at any of numerous positions in order to facilitate the selection of a work piece from the pre-plated member transport station 40. In an exemplary embodiment, the position of the truss assembler 52 may be controlled (e.g., by the control station 70 or a local control station) in order to enable efficient truss assembly. In other words, the various degrees of freedom of motion available to the truss assembler 52 due to its capabilities for motion relative to the jigging table 56 and the suspension carriage 59 may enable advantageous positioning of the truss assembler to optimize (e.g., minimize or reduce) motion requirements during truss assembly, while enabling finished portions (e.g., completed joints) to be rolled over for at least partial plate fastening.

In an exemplary embodiment, the truss assembler 52 may include an articulated arm and selection mechanism for gripping work pieces. The selection mechanism may include a robotic hand or pincer device for applying pressure to opposite sides of the work piece in order to grab and/or lift the work piece. In some cases, the selection mechanism may include fingers, protrusions or other detents that may slide or extend below the bottom surface of a lifted work piece in order to provide more support for work piece lifting.

The truss assembler 52 may then orient the selected work piece in accordance with the truss design data to place the work piece in the jig at the correct location. Because at least some of the work pieces may be pre-plated, the order in which the work pieces are placed on the jigging table 56 may be important. Notably, although the order in which the work pieces are placed on the jigging table 56 may be important for truss assembly, this does not necessarily mean that only one order is acceptable. To the contrary, numerous different orderings may be suitable for some truss designs. However, in each case, the ordering of work piece placement with respect to the placement of pre-plated members for any joint may be provided to ensure that the first board in any joint includes the bottom plate and the last board in the joint includes the top plate. For example, for any particular joint within a truss, a work piece corresponding to the first piece that will form the joint may include the bottom plate and a work piece corresponding to the last piece that will form the joint may include the top plate. Accordingly, since the first piece for any joint includes the bottom plate, other pieces meeting the first piece at the joint may be placed in their respective positions relative to the first piece without complication. Then, when the last piece is placed relative to the other pieces, the joint may be complete with the addition of the top plate along with the last piece.

The jigging table 56 may include mobile jig stops that may be configured to be movable to a desirable location along the jigging table 56 to form a jig. As such, in an exemplary embodiment, the jigging table 56 may be comprised of a plurality of flat slats that extend in the second direction parallel to each other to span the width of the jigging table 56. The mobile jig stops may be configured to ride in gaps defined between the flat slats to a desired position. In an exemplary embodiment, the jigging table 56 may include a jig stop placement assembly including a plurality of drive motors configured to move the mobile jig stops to a desired location on the jigging table 56. In an exemplary embodiment, the mobile jig stops may be moved automatically to form a jig based on truss design data that may correspond to a particular job or job identifier that may be entered locally or received from the control station 70. The mobile jig stops positioned to form the jig may assist the truss assembler 52 by holding placed pieces relatively steady while each new piece is added to form the truss. The mobile jig stops may also assist the truss assembler 52 by providing position information or landmarks for the truss assembler 52 to use in positioning work pieces in their respective proper locations.

Once a complete truss is assembled, the mobile gantry 58 will have been passed over the jigging table 56 to press the assembled truss and partially fasten the portion of the plates at each joint which are separate from the pre-plated portions. In an alternative embodiment, the mobile gantry 58 may make a continuous pass over the length of the jigging table 56 to press multiple assembled trusses. However, in a typical exemplary embodiment, as shown in FIG. 1, multiple gantries may be provided for use with each area in which a truss may be assembled on the jigging table 56. Additionally, as an alternative to simply providing one saw, one pre-plating station, one jigging table, one assembly robot and one mobile gantry, multiple instances of any or all of the above may be provided.

In an exemplary embodiment, after an assembled truss has been pressed by the mobile gantry 58, the assembled truss may be passed to the truss transport station 60. In some embodiments, the jigging table 56 may include slots in a direction perpendicular to the long dimension of the jigging table 56 through which one or more vertical liftouts may be extended to lift at least one side of lightweight bars that may extend between the vertical liftouts. The lightweight bars may form a liftout assembly that may initially be positioned at a portion of the jigging table 56 such that the liftout assembly is between the jigging table and the assembled truss when the liftouts extend. Thus, the liftouts may be extendible to lift one side of the liftout assembly higher than the opposite side. Accordingly, sufficient slope may be provided to the liftout assembly to slide the assembled truss off of the liftout assembly and onto the truss transport station 60. The liftouts may be pneumatically, hydraulically, or electrically operated to lift a side of the liftout assembly that is proximate to the pre-plated member transport station 40 and opposite of the truss transport station 60.

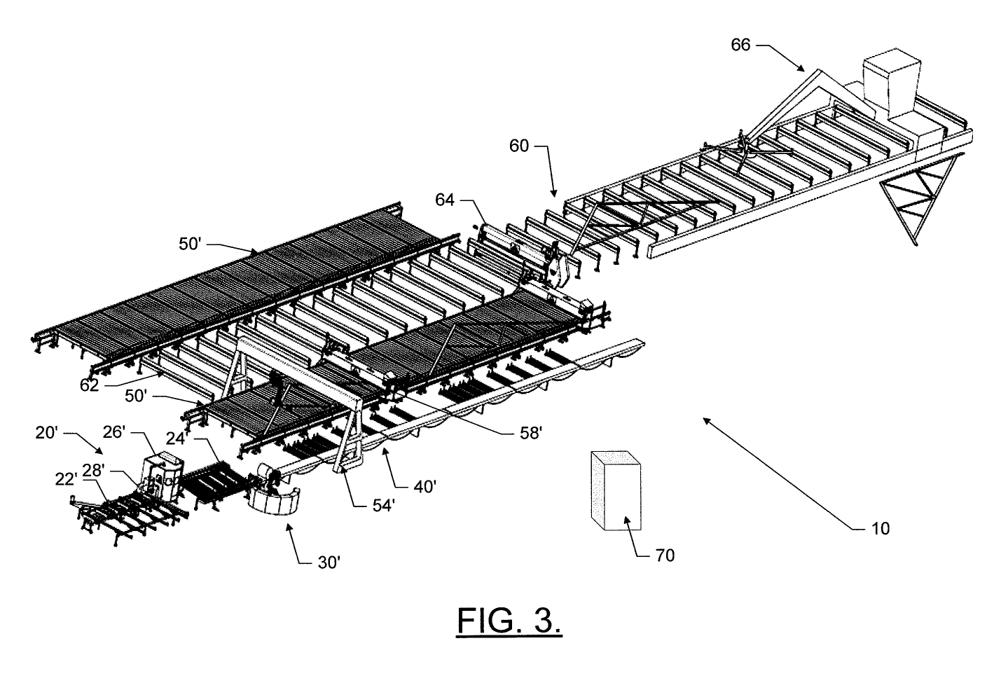

As shown in FIG. 1, the truss transport station 60 may serve a single truss assembly station. However, in alternative embodiments (such as the embodiment of FIG. 3) two separate truss assembly stations (each of which may include a respective cutting station, pre-plating station, and pre-plated member transport station). FIG. 3 illustrates an alternative construction for the system 10 of FIG. 1. In this regard, system 10′ of FIG. 3 includes various alternative embodiments for at least some of the components described above. FIG. 3 will not be described in detail since the components of FIG. 3 that have similar functional descriptions to those similarly numbered (except without the “prime” modifier) elements from FIG. 1 have already been described above. Instead, with respect to FIG. 3, it should be noted that rather than being placed on the mobile gantry 58, as in FIG. 1, the mobile gantry 58′ of FIG. 3 merely houses the single roller and a separate gantry 54 is provided to suspend the truss assembler 52′. The truss transport station 60 may include a roller assembly 62, a double roller final press 64. The embodiment of FIG. 3 also includes a knuckleboom truss stacker 66. The roller assembly 62 may include powered and/or non powered rollers provided in an array to form a conveyance mechanism for transporting an assembled truss through the final roller press 64 and on to the knuckleboom truss stacker 66 for stacking and/or shipment. The knuckleboom truss stacker 66 may include an arm configured to enable grasping, lifting, translating and stacking of assembled trusses. However, other mechanisms for truss stacking are also available (e.g., manual stacking, a device that moves a truss off rollers horizontally onto a stack at a lower elevation, rotating a truss of a roller system into a substantially vertical position and onto a rack that can hold a group of vertically oriented trusses. As shown in FIG. 3, prior to reaching the knuckleboom truss stacker 66, the assembled truss may be finally pressed to ensure full seating of the plates of each joint of the truss by the double roller final press 64. The double roller final press 64 may include two relatively large rollers moving in opposite directions spaced apart by about the thickness of a work piece in order to fully imbed teeth or engagement members on one face of the plates into the work piece.

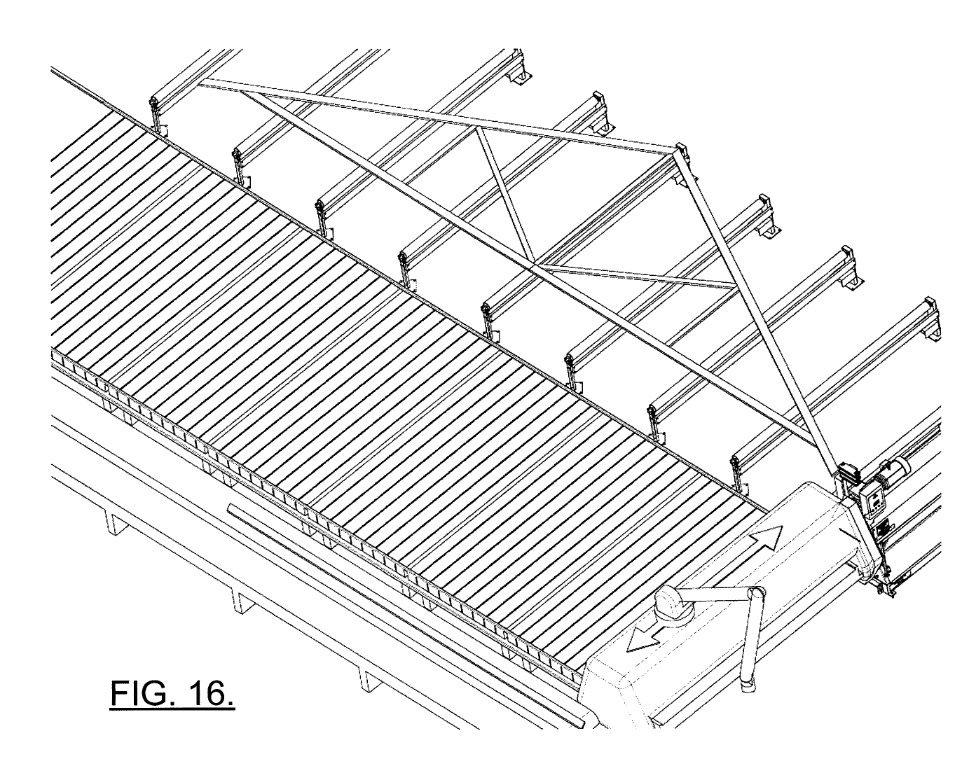

A sequence of truss assembly according to an exemplary embodiment will now be discussed in reference to FIGS. 1 and 4-16. Of note, although work pieces used in embodiments of the present invention may, in many cases, be pre-plated, the work pieces shown in FIGS. 1 and 4-16 will not be shown with plates attached in order to simplify the depiction of such elements. Referring first to FIG. 1, a first chord 101 is provided on the first member transporter 42. The first chord 101 may be indexed along the first member transporter 42 (e.g., under control from the control station 70) to a position proximate to its planned location in the assembled truss. A first web 201 may also be indexed along the second member transporter 44 to a position proximate to planned location in the assembled truss. In some embodiments, the provision of two member transporters may enable management of sequencing in a manner that enhances efficiency of truss assembly. In an exemplary embodiment, chords may be provided on one member transporter (e.g., the first member transporter 42) and webs may be provided on the other (e.g., the second member transporter 44) in the order in which they are to be placed in the truss based on the truss design data. However, in alternative embodiments, each of the first and second member transporters 42 and 44 may alternately receive work pieces according to the order of placement to improve the likelihood that the next piece to be placed may be available without delay after placement of the previous work piece. Other alterative arrangements are also possible.

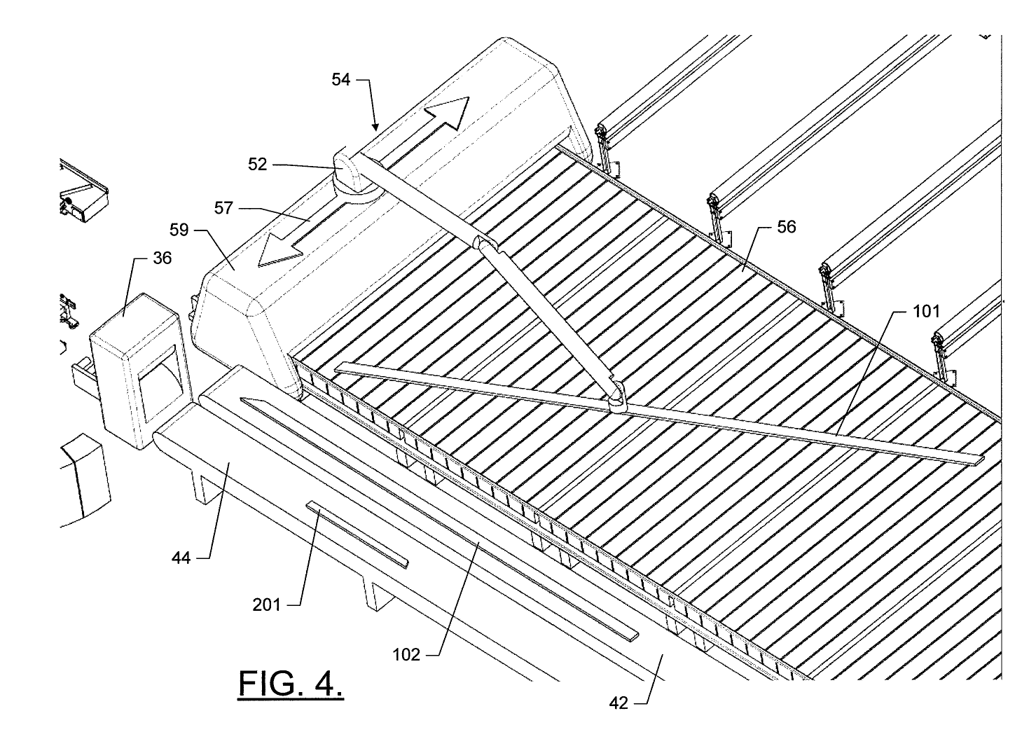

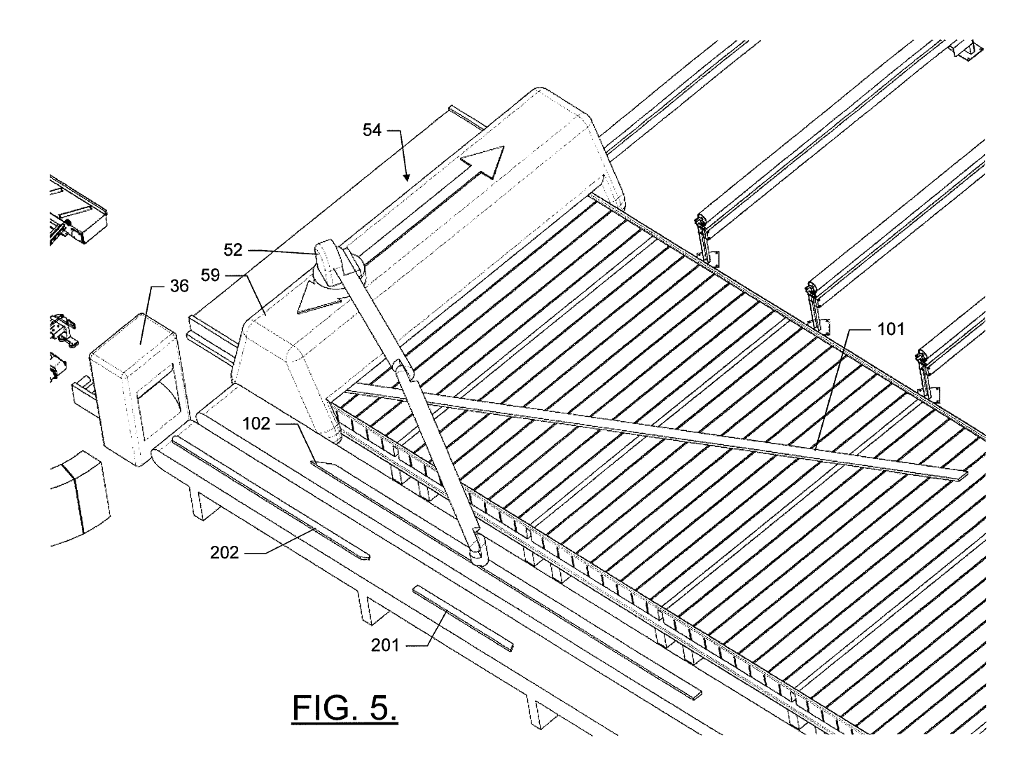

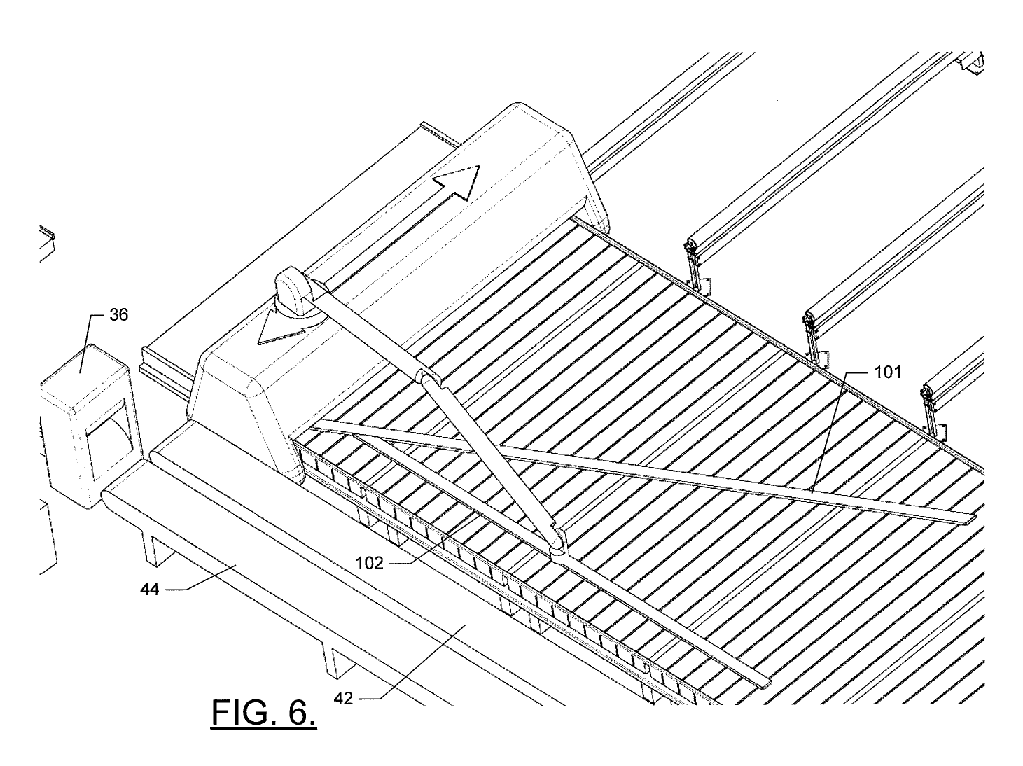

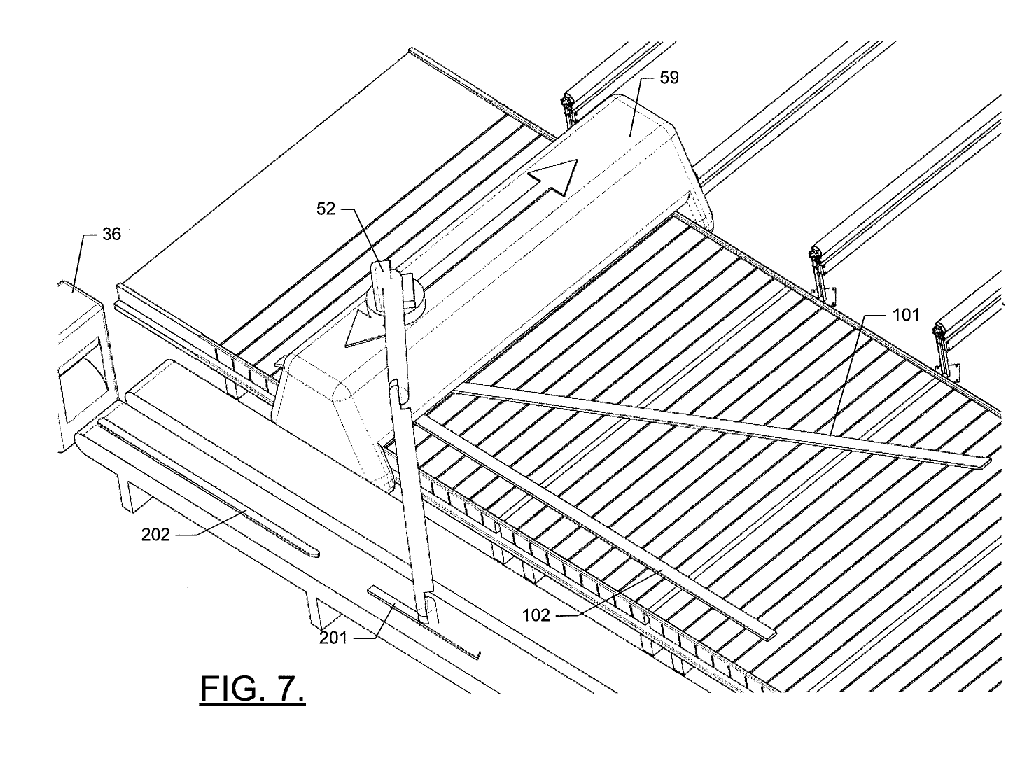

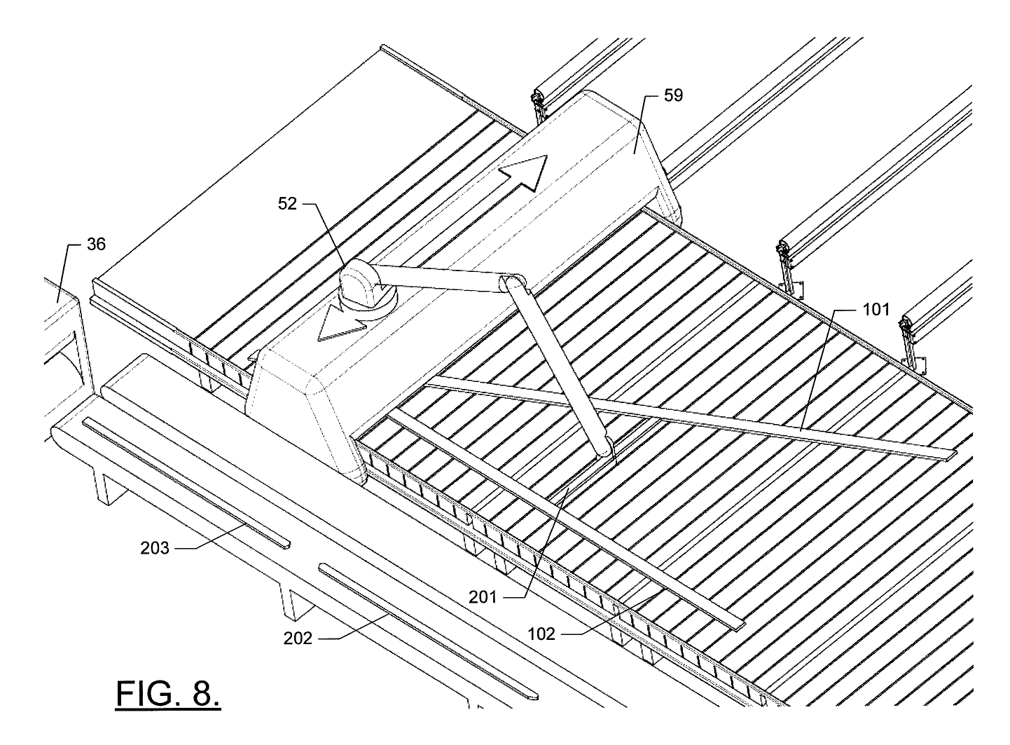

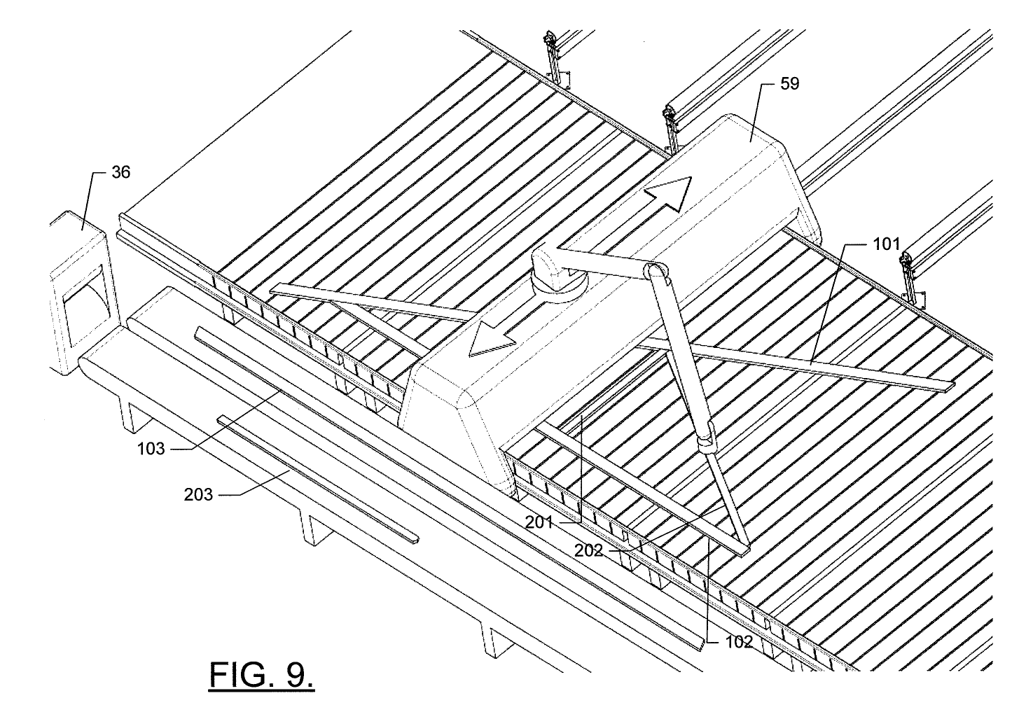

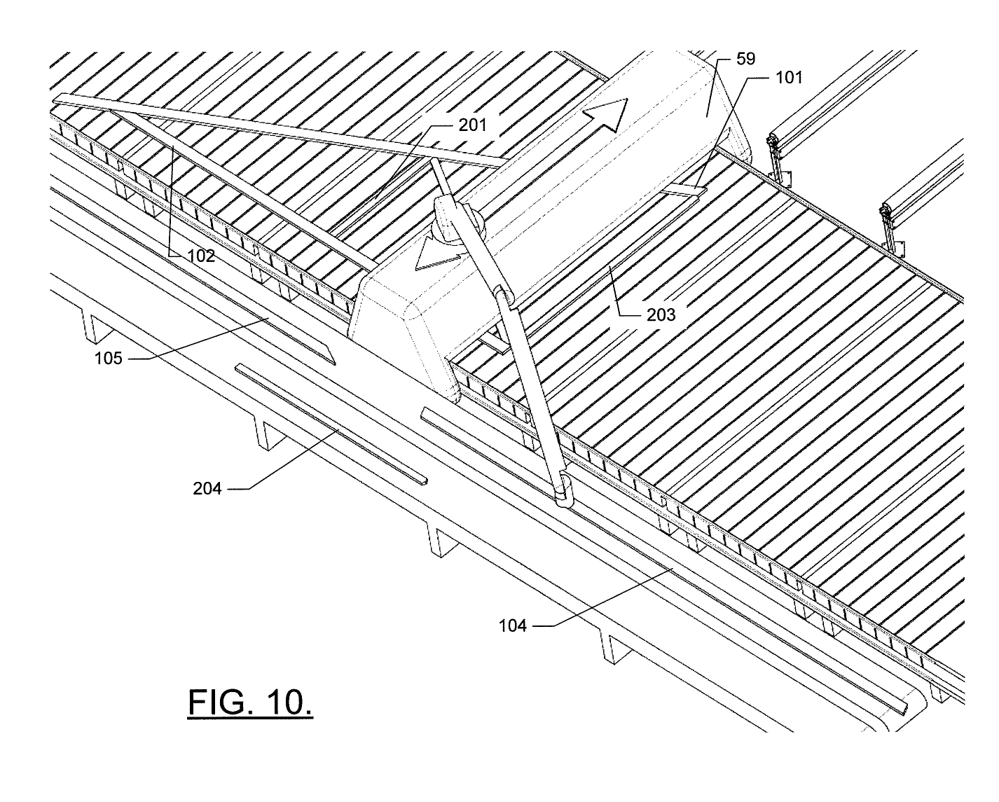

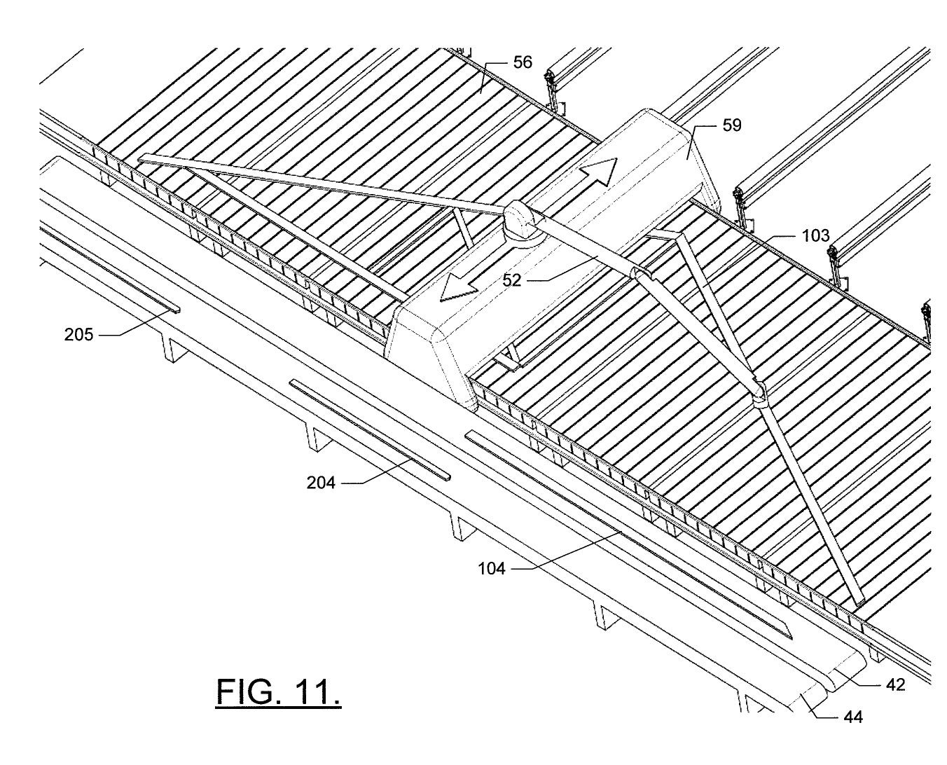

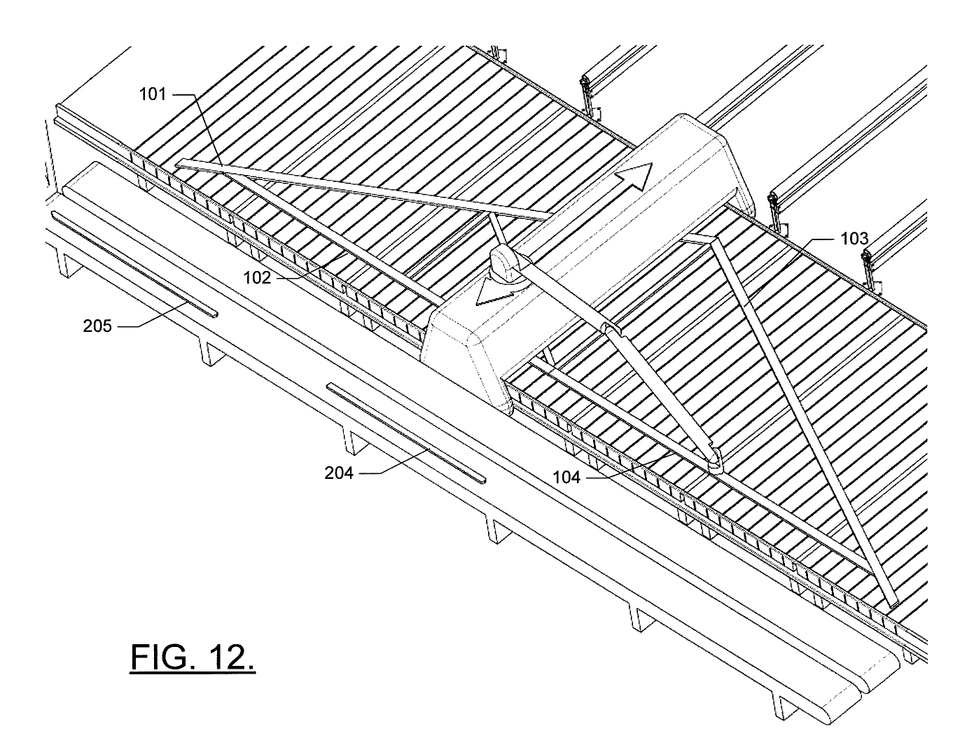

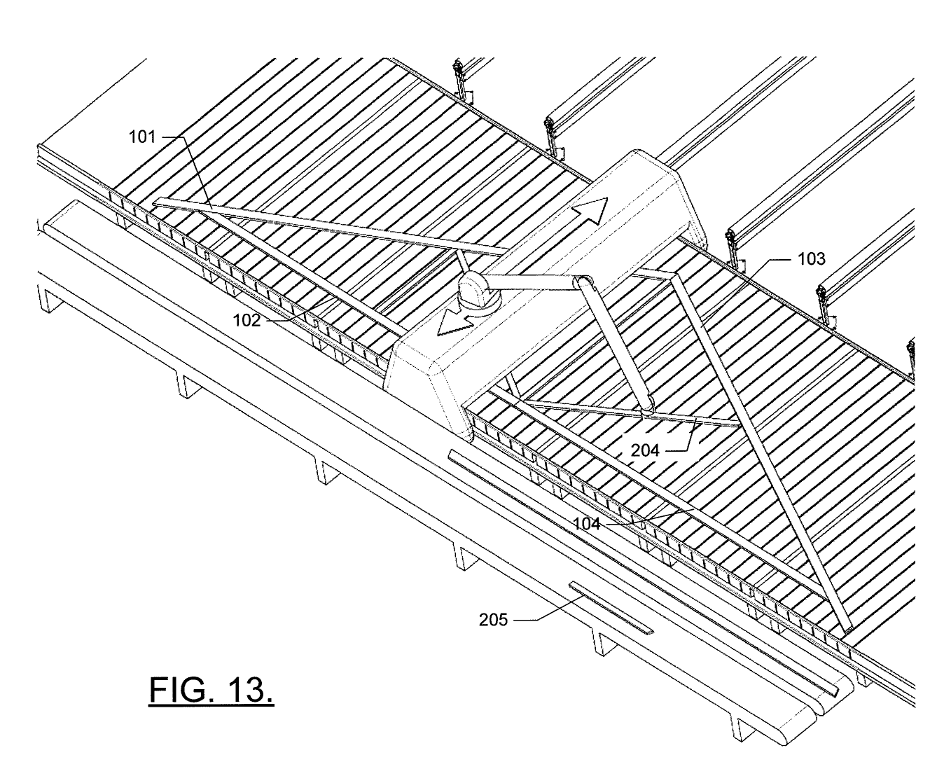

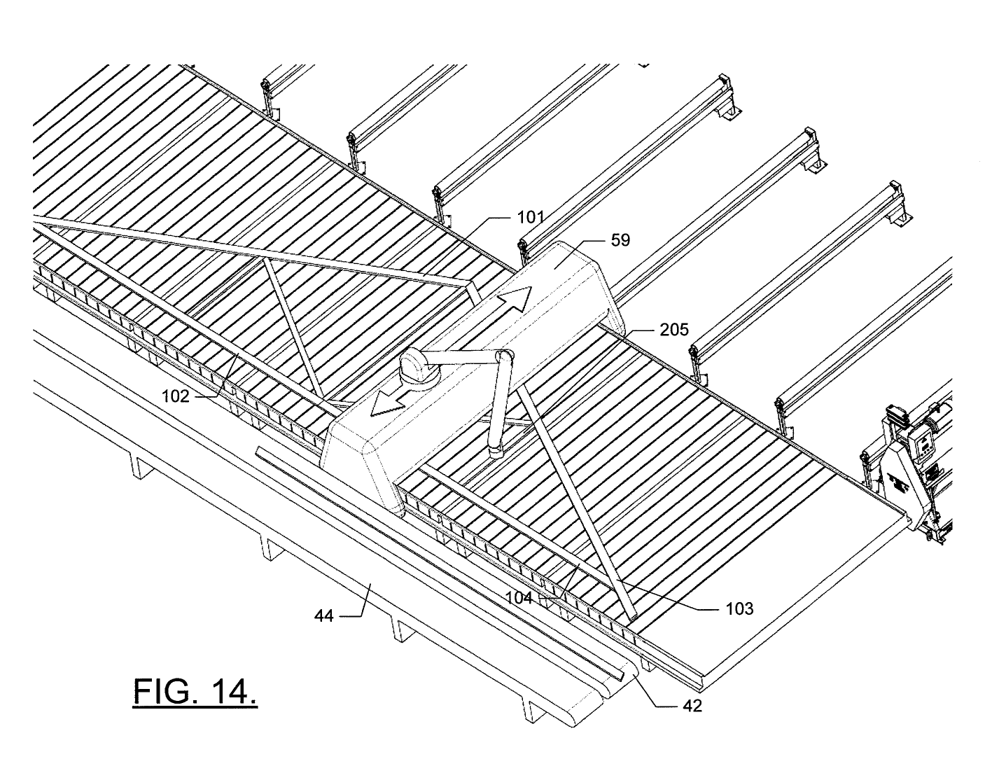

As shown in FIG. 4, the first chord 101 may be placed on the jigging table 56 at a location based on the truss design data while a second chord 102 is advanced into position proximate to the jigging table 56. As shown in FIG. 4, after selecting the first chord 101, the truss assembler 52 may be moved atop the suspension carriage 59 from a position relatively closer to the first member transporter 42 in FIG. 1 for facilitating work piece selection, to a position relatively farther away from the first member transporter 42 (e.g., a more central position relative to the top of the suspension carriage 59) for facilitating placement of the work piece. The truss assembler 52 may then again move closer to the first member transporter 42 and the second chord 102 may then be selected as shown in FIG. 5. The second chord 102 may then be placed relative to the first chord 101 on the jigging table 56 as shown in FIG. 6. After placement of the second chord 102, a joint between the first chord 101 and the second chord 102 may be complete. Accordingly, the mobile gantry 58 may advance (as shown in FIG. 7) such that the single roller of the mobile gantry 58 may roll over the joint between the first chord 101 and the second chord 102 to ensure partial fastening of the plates of the joint. The first web 201 may also be selected (FIG. 7) and then placed as shown in FIG. 8. A second web 202 may then be placed after being advanced by the second member transporter 44 and selected by the truss assembler 52 as shown in FIG. 9. A joint between the first chord 101, the first web 201 and the second web 202 may then be rolled over along with the joint between the second chord 102 and the first web 201 and a third web 203 may be placed as shown in FIG. 10. A third chord 103 and a fourth chord 104 may then be sequentially placed as shown in FIG. 11 and FIG. 12, respectively, after being advanced and selected. (It should be noted that this is merely one optional assembly progression, but other progressions may be utilized or even preferred in some cases. For example, the two chords 103 and 104 could be placed before the third web 203 so that the third web 203 will be confined by all the chords it contacts when it is placed.) A fourth web 204 and a fifth web 205 may then be sequentially placed as shown in FIG. 13 and FIG. 14, respectively, after being advanced and selected. As indicated above, after each joint is complete, the mobile gantry 58 may advance over the joint to fasten the plates of the joint and to facilitate better access to selection and placement positions for subsequent work pieces.

When all chords and webs have been assembled, the mobile gantry 58 may pass over the remaining joints and be positioned at an opposite end of the jigging table 56 from the end at which assembly began as shown in FIG. 15. Although the mobile gantry 58 could be returned to the end of the jigging table at which assembly began, it may be desirable to minimize unnecessary mobile gantry 58 motion. As such, for example, the mobile gantry 58 may remain at the opposite end of the jigging table 56 from the end at which assembly began in order to enable the truss assembler 52 to assemble another truss in the reverse order from that illustrated in FIGS. 4-14. After completion of the assembly, the completed truss may be transferred to the truss transport station 60 (e.g., by the liftout assembly described above.

Accordingly, embodiments of the present invention may provide a mechanism for cutting, pre-plating, and transporting truss members (e.g., work pieces) to a station at which the members may be assembled automatically and thereafter prepared for shipment to the customer. Thus, a fully implemented system as described above may enable substantially full automation of the truss manufacturing process. Moreover, for each different truss design, automatic setup may be accomplished. In this regard, for example, either from a central location (e.g., the control station 70) or merely by entering data at each individual station, truss design data may be provided to various components at the stations described above to enable automatic setup of the stations or components for the performance of functions according to the truss design data. In an exemplary embodiment, the truss design data could be included in or indicated by indicia that may be provided on each work piece and read therefrom during the assembly process.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

That which is claimed:

1. A truss assembler comprising:
a mobile gantry suspended a predetermined distance from a surface of a jigging table, the mobile gantry being configured to move relative to the surface of the jigging table,
wherein the truss assembler is configured to enable assembly of a truss from truss members by providing an automatic sequential placement of the truss members based at least in part upon a planned location of pre-plated truss members within an assembled truss.

2. The truss assembler of claim 1, wherein the truss assembler is configured to sequentially place the truss members including at least one truss member having at least one connector plate installed thereon prior to placement by the truss assembler at the jigging table.

3. The truss assembler of claim 2, wherein the mobile gantry includes a suspension carriage comprising a roller disposed above the surface by about a width of the truss members to enable the suspension carriage to at least partially seat the at least one connector plate as the roller rolls over the at least one connector plate.

4. The truss assembler of claim 3, wherein the suspension carriage extends across the jigging table in a direction substantially perpendicular to a long axis of the jigging table.

5. The truss assembler of claim 3, wherein the suspension carriage includes a servomotor configured to move the truss assembler over a surface of the suspension carriage in a direction substantially perpendicular to a long axis of the jigging table.

6. The truss assembler of claim 1, wherein the truss assembler comprises a robotic arm.

7. The truss assembler of claim 6, wherein the robotic arm includes an articulated selection member with multiple degrees of freedom.

8. The truss assembler of claim 1, wherein the mobile gantry is configured to move the truss assembler along a long axis of the surface to enable the truss assembler to selectively place truss members on the jigging table.

9. A truss assembly station comprising:
a jigging table for assembling a truss thereon; and
a truss assembler disposed at a mobile gantry, the mobile gantry being suspended a predetermined distance from a surface of the jigging table and configured to move relative to the surface, the truss assembler being configured to enable assembly of a truss from truss members by providing an automatic sequential placement of the truss members based at least in part upon a planned location of pre-plated truss members within an assembled truss.

10. The truss assembly station of claim 9, wherein the truss assembler is configured to sequentially place the truss members including at least one truss member having at least one connector plate installed thereon prior to placement at the truss assembly station.

11. The truss assembly station of claim 9, wherein the mobile gantry includes a suspension carriage comprising a roller disposed above the surface by about a width of the truss members to enable the suspension carriage to at least partially seat the at least one connector plate as the roller rolls over the at least one connector plate.

12. The truss assembly station of claim 11, wherein the suspension carriage extends across the jigging table in a direction substantially perpendicular to a long axis of the jigging table.

13. The truss assembly station of claim 12, wherein the suspension carriage includes a servomotor configured to move the truss assembler over a surface of the suspension carriage in a direction substantially perpendicular to a long axis of the jigging table.

14. The truss assembly station of claim 9, wherein the truss assembler is configured to lift the truss members from a member transporter disposed proximate to the jigging table and extending parallel to a long axis of the jigging table.

15. The truss assembly station of claim 14, wherein the member transporter comprises a first member transporter for transporting chord truss members and a second member transporter for transporting web truss members.

16. The truss assembly station of claim 9, wherein the truss assembler comprises a robotic arm.

17. The truss assembly station of claim 16, wherein the robotic arm includes an articulated selection member with multiple degrees of freedom.

18. The truss assembly station of claim 9, wherein the mobile gantry is configured to move the truss assembler along a long axis of the surface to enable the truss assembler to selectively place truss members on the jigging table.

19. The truss assembly station of claim 9, wherein the mobile gantry is configured to start initiation of a truss assembly operation proximate to one end of the jigging table and move toward an opposite end of the jigging table in increments while advancing to facilitate selection and placement of subsequent truss members and pressing completed joints between placed truss members.

20. The truss assembly station of claim 19, wherein movement of the mobile gantry over a long axis of the jigging table is only in one direction during assembly of the truss.
